(19) United States
(12) Patent Application Publication
(10) Pub. No.: US 2009/0221378 A1
(43) Pub. Date: Sep. 3, 2009

(54) BOWLING PIN AND MANUFACTURING METHOD THEREOF

(76) Inventor: Nobufumi Suzuki, Shizuoka (JP)

Correspondence Address: BROWDY AND NEIMARK, P.L.L.C.;624 NINTH STREET, NW, SUITE 300, WASHINGTON, DC, 20001-5303, US

(21) Appl. No.: 11/816,844

(22) PCT Filed: Feb. 22, 2005
(86) PCT No.: PCT/JP2005/002822

§ 371 Date: Feb. 9, 2009

(51) Int. Cl. A63D 9/00; B29C 45/14

(52) U.S. Cl. 473/119; 264/274

(57) ABSTRACT

An upper core 25 and a lower core 23 are set in a core material forming mold 21, a synthetic resin in a molten state is injected into a cavity 27 through a gate 26 and, thereafter, the core material which includes an upper hollow portion 5a having an upper opening 7 which opens upwardly and a lower hollow portion 5b having a lower opening 11 which opens downwardly is formed by molding, an upper cap 9, a lower cap 13 and a display plate 109 are mounted on the core material 3, a projecting portion 37 of the upper cap 9 is fitted into a recessed portion 37a of an upper mold 39 thus forming an upper engaging portion, a pin 31a of a lower mold 31 is fitted into a recessed portion 13a of the lower cap 13 thus forming a lower engaging portion, the core material 3 is vertically fixed to the inside of the cavity 28 while maintaining a gap 28a around the core material 3, and a molten resin is injected into the gap 28a through a gate 51 thus forming the skin portion 15 and integrally covering the upper cap 9, the lower cap 13 and the core material 3 with the skin portion 15.

### TECHNICAL FIELD

The present invention relates to a bowling pin and a manufacturing method thereof.

### BACKGROUND ART

People popularly enjoy bowling not only as an easily accessible leisure but also as a sport.

With respect to a pin which is served for bowling, easy-to-fall property when a ball hits the pin or other pin hits the pin is important. That is, provided that conditions such as an impact force and an impact angle at the time of hitting are equal among pins, uniform easy-to-fall property is required. Accordingly, based on the International Standard, a shape and a weight of the bowling pin are strictly determined such that a height is 38 cm, a size of a maximum diameter portion is 12 cm, a diameter of a bottom surface is 6 cm, a weight is not less than 1417 g and not more than 1644 g and the difference in weight among sets of pins each of which consists of ten pins arranged on each lane is less than 113 g.

The bowling pin is also required to generate a dry sound peculiar to the pin which is generated when the ball hits the pin or the pins hit each other and to have durability which can withstand the repeating hitting. Conventionally, a bowling pin which covers a surface of a wooden core material with a synthetic resin layer has been used. Further, on a surface of this wooden bowling pin, a display portion constituted of letters, patterns and the like is formed by coating by baking.

In patent document 1, for example, there is disclosed a bowling pin in which a circumferential groove having a proper width and a proper depth is arranged in a periphery of a largest diameter portion of a wooden bowling pin body, a synthetic-resin-made strip is fitted into the circumferential groove, a longitudinally elongated hollow space is formed at a center of the minimum diameter portion, a core rod made of a synthetic resin is fitted in the hollow space, and an outer surface of the bowling pin body is covered with an outer film made of a synthetic resin.

However, the bowling pin body of the bowling pin disclosed in patent document 1 is made of wood and hence, the bowling pin has several drawbacks.

For example, a weight of the ball becomes approximately 7.5 kg at maximum and hence, when the ball hits the pin, together with a speed attributed to throwing of the ball, the energy of the ball is extremely large. Accordingly, although a use period of the pin may depend on the frequency of use of the pin, the pin must be exchanged with a new pin at an interval of approximately several months thus giving rise to a drawback that the use period of the pin is relatively short.

Accordingly, as the core material of the bowling pin, there has been proposed a core material made of a synthetic resin which exhibits excellent durability (patent document 2).

[Patent document 1] JP-UM-A-6-77781
[Patent document 2] JP-A-2002-205316

### DISCLOSURE OF THE INVENTION

### Problems that the Invention is to Solve

However, the bowling pin disclosed in patent document 2 has following drawbacks.

The patent document 2 proposes a so-called two-layered resin bowling pin in which a core portion is formed by feeding a molten resin into a cavity of a first mold and by solidifying the resin thus forming a skin on the core portion by molding. In forming the skin, holes are formed in upper and lower portions of the core material for fixing the core material to the molds, and a resin-made lid is press-fitted into the holes in a final step of the manufacture of the bowling pin. However, there arises a drawback that the lid often falls from the bowling pin due to a strong impact which the bowling pin repeatedly receives during a bowling game.

The present invention has been made in view of the above-mentioned conventional drawbacks and it is an object of the present invention to provide a bowling pin which exhibits excellent durability while satisfying conditions such as a shape and a weight which the bowling pin is required to satisfy and a dry sound which is generated at the time of hitting, and a manufacturing method thereof.

Further, it is another object of the present invention to provide a bowling pin of high durability which can prevent a cap from being removed from the bowling pin even when the bowling pin receives a strong impact or a friction and a manufacturing method thereof.

### Means for Solving the Problem

To achieve the above-mentioned object, a manufacturing method of a bowling pin according to claim 1 includes:

a core material manufacturing step for forming a core material having a shape smaller than a profile of the bowling pin by molding; and

a skin portion forming step for covering an outer surface of the core material, wherein

the core material 3 which includes an upper hollow portion 5a having an upper opening 7 which opens upwardly and a lower hollow portion 5b having a lower opening 11 which opens downwardly is formed by molding by setting an upper core 25 and a lower core 23 in a core material forming mold 21 and by injecting a synthetic resin in a molten state into a cavity 27 through a gate 26, and

the skin portion 15 is formed by mounting an upper cap 9, a lower cap 13 and a display plate 109 on the core material 3, by fitting a projecting portion 37 of the upper cap 9 into a recessed portion 37a of an upper mold 39 to form an upper engaging portion, by fitting a pin 31a of a lower mold 31 into a recessed portion 13a of the lower cap 13 thus forming a lower engaging portion, and vertically fixing the core material 3 in the inside of a cavity 28 while maintaining a gap 28a around the core material 3, and injecting a molten resin into the gap 28a through a gate 51,

whereby the upper cap 9 and the lower cap 13 are integrally covered with the core material 3 by the skin portion 15.

A bowling pin according to claim 2 includes: a core material having a shape smaller than a profile of the bowling pin by molding; and

a skin portion for covering an outer surface of the core material, wherein

the core material 3 includes an upper hollow portion 5a having an upper opening 7 which opens upwardly and a lower hollow portion 5b having a lower opening 11 which opens downwardly and is formed by setting an upper core 25 and a lower core 23 in a core material forming mold 21, and by injecting a synthetic resin in a molten state into a cavity 27 through a gate 26, and the skin portion is formed by mounting an upper cap 9, a lower cap 13 and a display plate 109 on the core material 3, by fitting a projecting portion 37 of the upper cap 9 into a recessed portion 37a of an upper mold 39 thus forming an upper engaging portion, by fitting a pin 31a of a lower mold 31 into a recessed portion 13a of the lower cap 13 thus forming a lower engaging portion, by vertically fixing the core material 3 in the inside of a cavity 28 while maintaining a gap 28a around the core material 3, and by injecting a molten resin into the gap 28a through a gate 51,

whereby the upper cap 9 and the lower cap 13 are covered together with the core material 3 by the skin portion 15.

### ADVANTAGE OF THE INVENTION

As described above, according to the bowling pin of the present invention, the hollow portions are formed on both upper and lower end of the core material and the hollow portion is completely covered with the skin portion. Accordingly, even when the bowling pin repeatedly receives a strong impact during a bowling game, there is no possibility that the cap is removed or falls from the bowling pin.

Further, the bowling pin of the present invention is manufactured in a molded state of the caps as deformation prevention materials in which a compression force of the skin portion acts on a surface of the core material having the hollow portion and hence, there is no possibility that the bowling pin is deformed even when the bowling pin receives the strong impact of the ball.

### BRIEF DESCRIPTION OF THE DRAWINGS

FIG. 1 A schematic appearance view showing the constitution of a bowling pin of the present invention.

FIG. 2 A plan view for explaining a display portion according to a mode for carrying out the present invention.

FIG. 3 A cross-sectional view taken along a line A-A in FIG. 2.

FIG. 4 A cross-sectional view taken along a line B-B in FIG. 2.

FIG. 5 A schematic view for explaining a method for manufacturing the bowling pin of the present invention.

FIG. 6 A perspective view with a part broken away of a core material which is formed by molding and is ejected from a core material forming mold.

FIG. 7 A schematic view showing a state that the core material is fixed in a cavity 28 in the inside of a skin portion forming mold.

FIG. 8 A schematic explanatory view showing steps for forming two line portions 17.

### EXPLANATION OF SYMBOLS

1: bowling pin
3: core material
5a: upper hollow portion
5b: lower hollow portion
6: bottom portion
7: upper opening
8, 29: stepped portion
9: cap
11: lower opening
13: lower cap
13a: recessed portion
13b: inclined surface
13c: lower rib
15: skin portion
17: line portion
21: core material forming mold
23: lower core
24: projecting portion
25: upper core
25a: projecting portion
25b: recessed portion
26: gate
27: cavity
28: cavity
28a: gap
31: lower mold
31a: pin
33: small hole
35: head portion
37: projecting portion
37a: recessed portion
39: upper mold
51: gate
52: recessed portion
104: letter and pattern
109: display portion
202: boss
204: display body
206: transparent plate

### BEST MODE FOR CARRYING OUT THE INVENTION

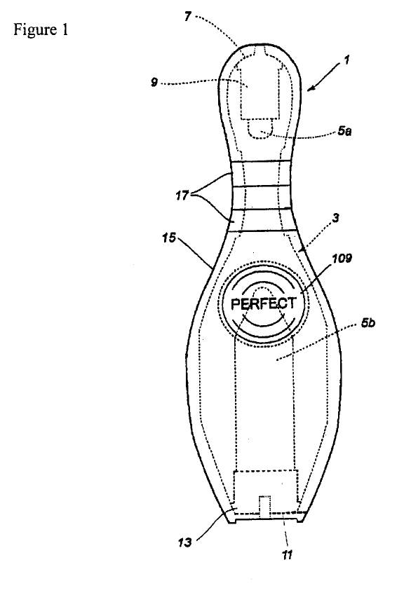

A bowling pin and a manufacturing method thereof according to the present invention are explained in conjunction with FIG. 1 to FIG. 8.

FIG. 1 is a schematic appearance view showing the constitution of a bowling pin. In FIG. 1, a symbol 3 indicates a core material. An upper hollow portion 5a is formed in an upper portion of a core material 3 and a lower hollow portion 5b is formed in a lower portion of the core material 3. A synthetic resin which forms a core material 3 is interposed between the upper hollow portion 5a and the lower hollow portion 5b, and the upper hollow portion 5a and the lower hollow portion 5b are not communicated with each other. The upper hollow portion 5a has an upper opening 7 which opens toward an upper end of the core material 3, while the lower hollow portion 5b has a lower opening 11 which opens toward a lower end of the core material 3. Further, an upper cap 9 which constitutes a deformation prevention member is fitted into the upper opening 7 formed in the upper hollow portion 5a, while a lower cap 13 which constitutes a deformation prevention member is fitted into the lower opening 11 formed in the lower hollow portion 5b.

Further, the core material 3, the upper cap 9 and the lower cap 13 are covered with a skin portion 15. On portions of the core material 3 where the skin portion 15 is not formed, two line portions 17 and a display portion 109 which are exposed from the skin portion 15 are formed.

In the present invention, a type of synthetic resin which is used as a material of the core material 3 is not specifically limited. A polypropylene resin may be used as a preferred raw material of the core material 3.

The polypropylene resin is light-weighted, exhibits excellent heat resistance property and excellent injection-moldability, and possesses proper rigidity, proper impact strength and proper hardness and hence, the polypropylene resin is preferably used as the material of the core material. Further, the polypropylene resin is preferably used also in view of a low cost and recycling property.

With respect to properties of the core material, it is preferable that an Izod impact strength (with a notch, 20° C., ASTM D253) of the core material is 200 J/m or more and Rockwell R hardness (20° C., ASTM D 785) is 80 or more.

Further, based on the composition, the polypropylene resin is classified into homopolymer (monopolymer), and the random copolymer and block copolymer are copolymers. It is preferable to use block polymer which possesses an excellent impact resistance strength. As a commercially available polypropylene resin, for example, “J-750HP” produced by Idemitsu Kosan Co., Ltd. or the like is named.

Further, it is also possible to impart further excellent properties to the polypropylene resin by mixing other resin into polypropylene resin. For example, it may be possible to use a synthetic resin which is produced by mixing a polyamide resin into the polypropylene resin.

Further, reproduced pellets or the like may be also used as a material of the core material. The reproduced pellets which have the following composition, for example, can be used.

Admer (trademark) 9 to 15% (percent by weight)

nylon 6(trademark) 0 to 46% (percent by weight)

nylon 666 (trademark) 0 to 33% (percent by weight)

nylon 12 (trademark) 0 to 8% (percent by weight)

EVOH resin 0 to 21% (percent by weight)

EVAR (trademark) 0 to 39% (percent by weight)

PE (polyethylene) 0 to 53% (percent by weight)

PP (polypropylene) 0 to 45% (percent by weight)

These reproduced pellets are controlled and mixed to become 100% in total.

It is preferable that the skin portion 15 is also made of a synthetic resin having higher friction and wear resistances and higher impact resistance than the corresponding resistances which the core material 3 possesses. For example, a polyamide resin having an amide-group bond which is thermoplastic engineering plastic is preferably used. Polyamide resin possesses excellent friction and wear resistances and excellent impact resistance and hence, the polyimide resin is suitable as a material of the skin portion of the bowling pin.

As properties of the skin portion, it is preferable that an Izod impact strength (with a notch, 23° C., ASTM D253) is 600 J/m or more and Rockwell R hardness (23° C., ASTM D785) is 110 or more. The skin portion is required to have higher friction and wear resistances, higher impact resistance and higher hardness than the corresponding properties of the core material. This is because that the skin portion is a portion which directly receives an impact from the bowling ball and hence, the skin portion must be completely free from cracks, flaws and the like whereby extremely strict properties are required.

The polyamide resin may be classified into homopolymer (monopolymer) and copolymer nylon which constitutes copolymer depending on the composition thereof. Although both materials can be used as the raw material for the skin portion, a poly ε-caproamide resin ([NH(CH₂)5CO]ₙ, nylon 6) can be preferably used.

Further, by mixing a trace quantity of the elastomer into the poly ε-caproamide resin, it is possible to impart glossiness and flexibility to the appearance of the skin portion and hence, the poly ε-caproamide resin can be further preferably used as the material of the skin portion.

As a commercially available resin which mixes a trace quantity of elastomer into the poly ε-caproamide resin, for example, “Amilan U141” produced by Toray Industries Inc. or the like can be used.

Further, by mixing other resin or pigment into the polyamide resin, it is also possible to further impart other properties to the skin portion. For example, it may be also possible to color the skin portion in an ivory-system color by mixing pigments into the polyimide resin.

According to the present invention, it is unnecessary to apply primer or clear painting to an upper layer of the skin portion 15. The synthetic resin of the above-mentioned skin portion is extremely hard and has the excellent flaw resistance, the excellent friction and wear resistances, the excellent impact resistance or the like and hence, a surface of the skin portion can be kept clean without applying any coating. Further, when the polyamide resin is used for forming the skin portion, adhesion property of the coating applied to the skin portion is decreased and hence, clear coating or the like is peeled off during use thus deteriorating the appearance of the skin portion to the contrary.

Here, the present invention is characterized in that, as the material of the core material, a synthetic resin which exhibits high injection-moldability, possesses excellent rigidity, excellent impact strength and excellent hardness, is obtained at a low-cost and possesses recycling property is used, while as the material of the skin portion, a synthetic resin which possesses higher friction and wear resistances, higher impact resistance and higher hardness than the corresponding resistances and hardness which the core material possesses is used.

Next, the display portion is explained.

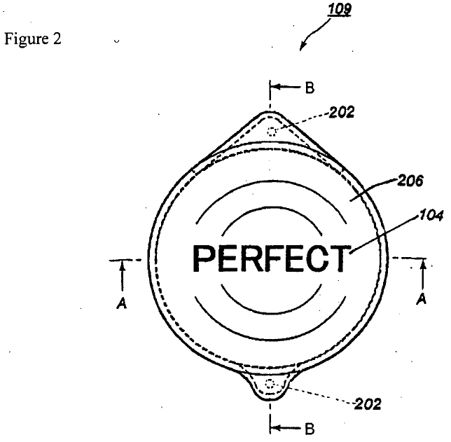

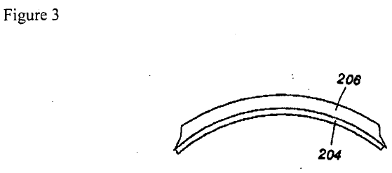

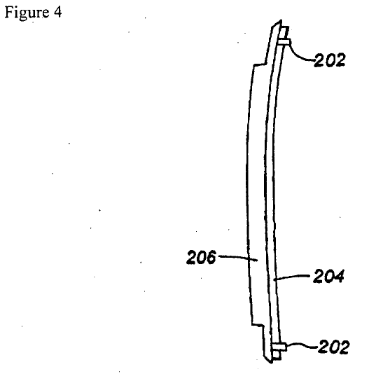

FIG. 2 is a plan view for explaining the display portion according to the mode for carrying out the present invention, and FIG. 3 is a cross-sectional view taken along a line A-A in FIG. 2, and FIG. 4 is a cross-sectional view taken along a line B-B in FIG. 2.

As shown in FIG. 2 to FIG. 4, in this mode for carrying out the present invention, the display portion 109 is constituted of a curved transparent plate 206, a display body 204 and bosses 202 which are adhered to a back side of the transparent plate 206.

The transparent plate 206 is formed in a curved shape which conforms to the circumference direction of the bowling pin, and a display body 204 on which a character or a pattern is printed is adhered to a back side of the transparent plate 206 using a transparent adhesive agent.

As a material for forming the transparent plate 206, a transparent resin such as a polycarbonate resin is used.

As a material for forming the display body 204 on which a character or a pattern is printed, a sheet-like material such as a plastic film or paper is used.

In this mode for carrying out the present invention, the bosses 202 are respectively formed on upper and lower portions of the back side of the transparent plate 206 one for each portion in a projecting manner. The bosses 202 are respectively fitted into small holes 33 formed in the core material 3 so as to fix the display portion 109 to the core material 3.

Here, by directly printing the character or the pattern 104 printed on the display body 204 which is adhered to the back side of the transparent plate 206 on the back side of the transparent plate 206, the display body 204 may be omitted.

Next, a manufacturing method of a bowling pin according to the present invention is explained.

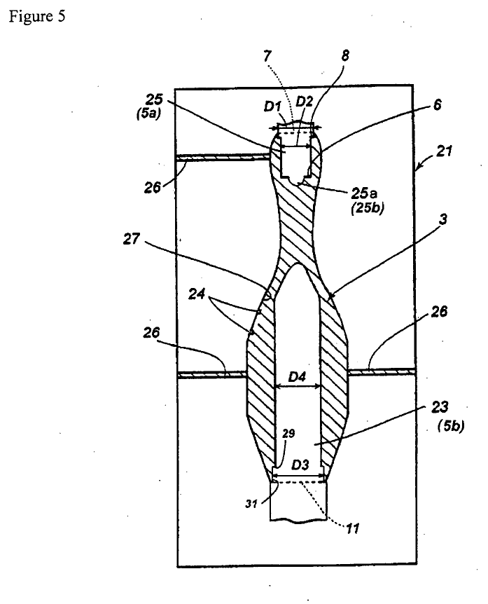

First of all, as a first step, the core material 3 is manufactured preliminarily. That is, as shown in FIG. 5, an upper core 25 and a lower core 23 for forming the upper hollow portion 5a and the lower hollow portion 5b are set on a core material forming mold 21, and a molten synthetic resin is injected into a cavity 27 through gates 26 so as to form the core material 3 by molding.

The molded core material 3 includes the upper hollow portion 5a having the upper opening 7 which opens upwardly and the lower hollow portion 5b having the lower opening 11 which opens downwardly. Stepped portions 8, 29 are formed on inner circumferences of the upper hollow portion 5a and the lower hollow portion 5b.

That is, the upper core 25 has a cylindrical shape having a semispherical projecting portion 25a formed on a lower end portion thereof, wherein a diameter size D1 of an upper end portion of the upper core 25 is set larger than a diameter size D2 of a lower end portion of the upper core 25. Accordingly, a recessed portion 25b which corresponds to the projecting portion 25a is formed in a bottom portion 6 of the upper hollow portion 5a, and the stepped portion 8 is formed on a peripheral wall of the upper hollow portion 5a due to the difference in diameter size.

In FIG. 5, the bottom portion 6 forms a bottom periphery of the upper hollow portion 5a and the stepped portion 8 is formed in the vicinity of the upper opening 7.

On the other hand, the lower core 23 has a rocket-like cylindrical shape having a round distal end, wherein a diameter size D3 of an lower end portion of the lower core 23 is set larger than a diameter size D4 of an upper portion of the lower core 23. Accordingly, the stepped portion 29 is formed on a peripheral wall of the lower hollow portion 5b due to the difference in diameter.

In FIG. 5, the stepped portion 29 is formed in the vicinity of the lower opening 11.

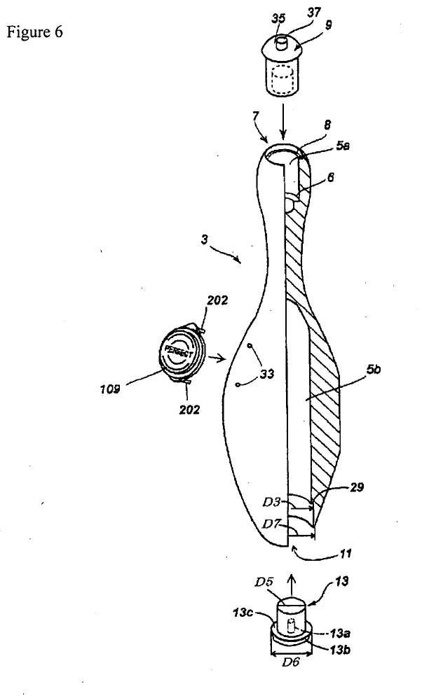

FIG. 6 is a perspective view with a part broken away of the core material 3 which is formed as shown in FIG. 5 and is ejected from the core material forming mold 21.

In FIG. 6, the upper hollow portion 5a and the lower hollow portion 5b are formed in the upper and lower portions of the core material 3, and the upper cap 9, the lower cap 13 and the display plate 109 are mounted on the core material 3.

First of all, when the upper cap 9 is pushed into the upper hollow portion 5a through the upper opening 7 of the core material 3, a lower end of the upper cap 9 is brought into contact with the bottom portion 6 of the upper hollow portion 5a, and a lower end of a portion of the upper cap 9 having the diameter size D1 is brought into contact with the stepped portion 8. Accordingly, the upper cap 9 is fitted into the inside of the upper hollow portion 5a and hence, a head portion 35 becomes coplanar with an outer surface of the upper opening 7 of the core material 3.

Here, a semispherical head shape 35 is formed on an upper surface of the upper cap 9. A projecting portion 37 which extends upwardly is formed on a center portion of the head portion 35 of the upper cap 9. The projecting portion 37 constitutes an upper engaging portion for engaging the core material 3 with a skin portion forming mold described later.

Next, when the lower cap 13 is pushed into the lower hollow portion 5b through the lower opening 11 of the core material 3, an upper end of the lower cap 13 is brought into contact with the stepped portion 29 of the lower hollow portion 5b, and the lower cap 13 is fitted into the inside of the lower hollow portion 5b.

Here, the lower cap 13 has a cylindrical shape as a whole, and the upper diameter D5 has a diameter size approximately equal to a diameter size D3 of the lower hollow portion 5b, and a lower rib 13c has an outer diameter size D6 approximately equal to an outer diameter size D7 of a lower end of the core material 3.

Further, a side wall of a lower portion of the lower cap 13 is inclined so as to form an inclined surface 13b which gradually decreases a diameter size thereof in the downward direction. When the lower cap 13 is fitted into the lower hollow portion 5b, the lower-portion side wall of the lower cap 13 becomes coplanar with a lower-end peripheral portion of the core material 3.

Here, a cylindrical recessed portion 13a which has a bottom thereof opened is formed in a center portion of a bottom surface of the lower cap 13, and the recessed portion 13a constitutes a lower engaging portion for engaging the core material 3 with a skin portion forming mold described later.

Further, the bosses 202 of the display portion 109 are respectively fitted into the small holes 33 to fix the display portion 109 to the core material 3.

Here, in the core material forming mold 21, projecting portions 24 for forming the small holes 33 in an outer peripheral surface of the core material 3 are formed in a state that the projecting portions 24 project into the inside of the cavity 27.

Here, the positions of the small holes 33 correspond to the upper and lower positions of the bosses 202 of the display portion 109.

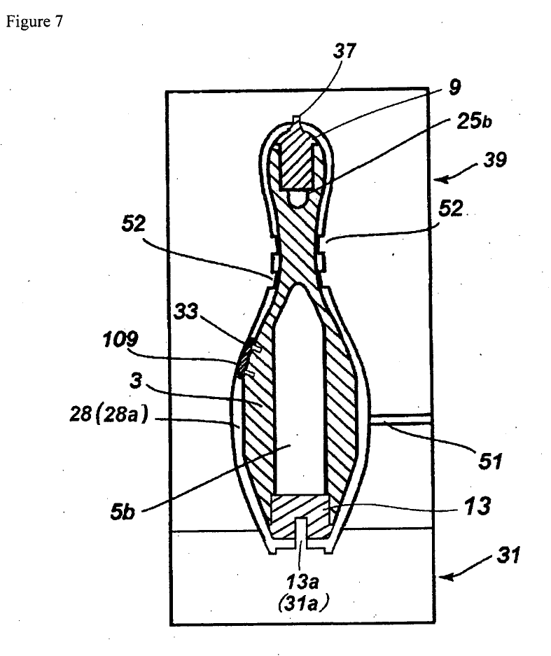

Next, as shown in FIG. 7, the core material 3 into which the upper cap 9, the lower cap 13 and the display plate 109 are pushed is fixed in the inside of the cavity 28 which is a space defined by an upper mold 39 and a lower mold 31 which constitute the skin portion forming mold.

Then, the skin portion 15 is formed by injecting a polyamide resin into the gap 28a formed between the core material and the cavity 28 through the gate 51 (see FIG. 1).

In fixing the core material 3 in the inside of the cavity 28, the projecting portion 37 of the upper cap 9 is fitted into the recessed portion 37a of the upper mold 39 to form the upper engaging portion, and the pin 31a of the lower mold 31 is fitted into the recessed portion 13a of the lower cap 13 to form the lower engaging portion and hence, the core material 3 can be fixed in the inside of the cavity 28 vertically while holding the gap 28a around the core material 3.

In this manner, the upper cap 9 and the lower cap 13 are substantially completely covered with the skin portion 15, and a recessed portion 52 at which a thickness of the skin portion 15 is small is formed in a squeezed portion or a neck portion of the core material 3 at two positions, that is, upper and lower positions.

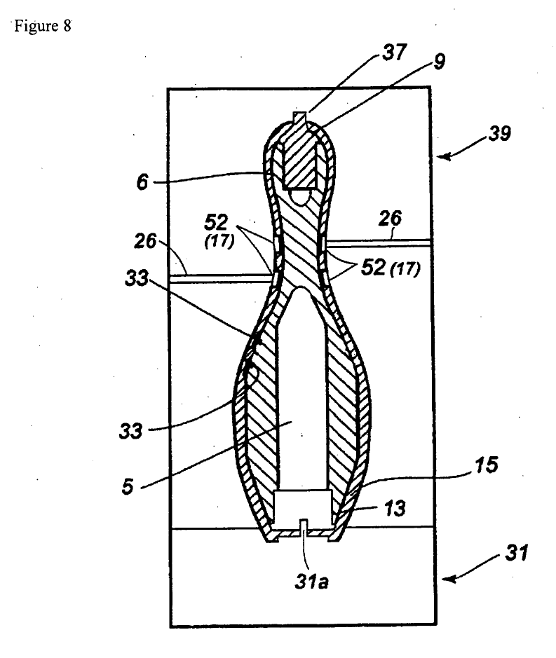

Next, as shown in FIG. 8, a red polyamide resin is injected into the recessed portions 52 through the gate 26 thus forming two line portions 17 by so-called two-color molding. Since the line portions 17 are formed by the synthetic resin filled in the recessed portions 52, there is no possibility that the line portions 17 disappear by wear different from line portions which are formed by coating.

When the skin portion 15 is formed, the display portion 109 is exposed (forming an exposed portion which exposes a display body from the skin portion).

As described above, the display portion 109 is formed of the polycarbonate or an urethane resin and hence, the display portion 109 is formed in a curved shape which conforms to the circumference direction of the skin portion.

As mentioned above, since the display body 104 of the display portion 109 is covered with the transparent plate 206, there is no possibility that the display portion 109 disappear by wear different from the display portion which is formed by coating.

the core material 3 which is covered with the skin portion 15, the line portions 17 and the like in the above-mentioned manner is removed from the lower mold 39 and the lower mold 31, and the projecting portion 37 of the head portion of the upper cap 9 is cut out to make the head portion of the upper cap 9 coplanar with an outer surface of the skin portion 15.

Here, the upper cap 9 and the lower cap 13 are completely molded with the skin portion 15 which is integrally covered with the core material 3 and hence, there is no possibility that the upper cap 9 and the lower cap 13 are removed from the core material 3 during the use of the bowling pin (see FIG. 1).

Although the embodiment of the present invention has been explained in detail heretofore, the specific constitution of the present invention is not limited to such an embodiment, and the present invention includes various design modifications without departing from the gist of the present invention.

### INDUSTRIAL APPLICABILITY

As has been explained heretofore, according to the bowling pin of the present invention, the upper cap is fitted into the upper hollow portion of the core material, the lower cap is fitted into the lower hollow portion of the core material, and polyamide resin used for forming the skin portion is injected into the inside of the cavity under pressure at a high temperature of 250° C. or more and hence, these parts are integrally formed by molding with the core material. Accordingly, the upper and lower cap are firmly fixed to the core material and hence, the core material is not deformed and can maintain a predetermined shape prescribed in the International Standard for a long time.

Further, in the bowling pin according to the present invention, as raw material of the core material, the synthetic resin which exhibits high injection-moldability and possesses excellent rigidity, excellent impact strength and excellent hardness, is obtained at a low cost and possesses excellent recycling property is used. Further, as the material of the skin portion, the synthetic resin which possesses higher friction and wear resistances, higher impact resistance and higher hardness than the corresponding resistances and hardness which the core material possesses is used and hence, the bowling pin can be used for an extremely long time.

Further, according to the bowling pin of the present invention, it is unnecessary to apply primer or clear painting to the upper layer the skin portion 15. The synthetic resin which forms the skin portion is extremely hard and has the excellent flaw resistance, the excellent friction and wear resistances, the excellent impact resistance and the like and hence, a surface of the skin portion can be kept clean without applying any coating.

Further, the core material is made of polypropylene resin and the skin portion is made of polyamide resin and hence, the bowling pin of the present invention exhibits excellent durability and excellent recycling property.

The bowling pin of the present invention is not peeled off even when the skin portion or the display portion of the bowling pin receives a strong impact or frictions and hence, the bowling pin can exhibit high durability and can reduce a in using the bowling pin.

1. A manufacturing method of a bowling pin comprising:
a core material manufacturing step for forming a core material having a shape smaller than a profile of the bowling pin by molding; and
a skin portion forming step for covering an outer surface of the core material, wherein
the core material 3 which includes an upper hollow portion 5a having an upper opening 7 which opens upwardly and a lower hollow portion 5b having a lower opening 11 which opens downwardly is formed by molding by setting an upper core 25 and a lower core 23 in a core material forming mold 21 and by injecting a synthetic resin in a molten state into a cavity 27 through a gate 26, and
the skin portion 15 is formed by mounting an upper cap 9, a lower cap 13 and a display plate 109 on the core material 3, by fitting a projecting portion 37 of the upper cap 9 into a recessed portion 37a of an upper mold 39 to form an upper engaging portion, by fitting a pin 31a of a lower mold 31 into a recessed portion 13a of the lower cap 13 thus forming a lower engaging portion, and vertically fixing the core material 3 to the inside of a cavity 28 while maintaining a gap 28a around the core material 3, and injecting a molten resin into the gap 28a through a gate 51,
whereby the upper cap 9 and the lower cap 13 are integrally covered with the core material 3 by the skin portion 15.

2. A bowling pin comprising:
a core material having a shape smaller than a profile of the bowling pin by molding; and
a skin portion for covering an outer surface of the core material, wherein
the core material 3 includes an upper hollow portion 5a having an upper opening 7 which opens upwardly and a lower hollow portion 5b having a lower opening 11 which opens downwardly which are formed by setting an upper core 25 and a lower core 23 in a core material forming mold 21, and by injecting a synthetic resin in a molten state into a cavity 27 through a gate 26 and, the skin portion is formed by mounting an upper cap 9, a lower cap 13 and a display plate 109 on the core material 3, by fitting a projecting portion 37 of the upper cap 9 into a recessed portion 37a of an upper mold 39 thus forming an upper engaging portion, by fitting a pin 31a of a lower mold 31 into a recessed portion 13a of the lower cap 13 thus forming a lower engaging portion, by vertically fixing the core material 3 in the inside of a cavity 28 while maintaining a gap 28a around the core material 3, and by injecting a molten resin into the gap 28a through a gate 51 whereby the upper cap 9 and the lower cap 13 are covered together with the core material 3 by the skin portion 15.
